(19) United States
(12) Patent Application Publication
(10) Pub. No.: US 2003/0229433 A1
(43) Pub. Date: Dec. 11, 2003

(54) AN AGRICULTURAL MACHINE FOR PERFORMING AN AGRICULTURAL OPERATION

(75) Inventors: Karel van den BERG, Bleskengraf (NL); Theo Jan MIEDEMA, Maasland (NL)

Correspondence Address: HOWREY SIMON ARNOLD & WHITE, CITYPOINT, ONE ROPEMAKER STREET, LONDON, EC2Y 9HS, GB

(73) Assignee: LELY ENTERPRISES AG, Zug (CH)

(21) Appl. No.: 10/250,099

(22) Filed: Jun. 4, 2003

(30) Foreign Application Priority Data
Jun. 6, 2002 (NL) 1020792

(51) Int. Cl. G06F 19/00

(52) U.S. Cl. 701/50; 701/23

(57) ABSTRACT

An agricultural machine for performing an agricultural operation. The agricultural machine is movable over an agricultural parcel and is provided with an environment-sensor for measuring a current value of an environment-property, with a memory for containing a nominal value of the environment-property, and with a comparator for comparing the measured current value of the environment-property with the stored nominal value of the environment-property. The agricultural machine is further provided with a direction-of-travel-determining element for determining the direction of travel of the agricultural machine and with a braking-distance-determining element for determining the braking distance of the agricultural machine.

### CROSS REFERENCE TO RELATED APPLICATIONS

This application claims priority from Dutch patent application no. 1020792 filed Jun. 6, 2002, the contents of which are hereby incorporated by reference in their entirety.

### BACKGROUND OF INVENTION

1. Field of the Invention

The invention relates to agricultural machines for performing agricultural operations and more particularly to autonomous agricultural machines that are movable without a driver.

2. Description of the Related Art

Agricultural machines are generally known in which it is principally the driver who is responsible for the safety of the environment and in particular living beings.

### SUMMARY OF INVENTION

According to the invention there is provided an agricultural machine for performing an agricultural operation, by means of which improved safety can be achieved.

For this purpose, according to the invention an agricultural machine of the above-described type comprises: an environment-sensor for measuring a current value of an environment-property; a memory for storing a nominal value of the environment-property; a comparator for comparing the measured current value of the environment-property with the stored nominal value of the environment-property; and a braking-distance-determining element for determining the braking distance of the agricultural machine. The invention is thus based on the insight that the expected braking distance of the agricultural machine does not only depend on the position of the agricultural machine in the agricultural parcel, but also on other factors such as the direction of travel, for example uphill and downhill. By means of the invention safety is improved in that the agricultural machine is provided with a braking-distance-determining element for determining the braking distance of the agricultural machine.

In an advantageous embodiment of an agricultural machine according to the invention the measuring range of the environment-sensor is adjustable with the aid of data from the braking-distance-determining element, in order to make it possible to stop the agricultural machine and to take other safety measures, if necessary, before the detected object has been reached.

It is in particular advantageous if the measuring range of the environment-sensor is adjustable with the aid of data from the direction-of-travel-determining element, in order that the environment is always detected in the direction of travel.

If the environment-sensor is movably disposed on the agricultural machine, the sensor can always be brought into a desired position. The environment-sensor is in particular movable with the aid of data from the direction-of-travel-determining element.

In a preferred embodiment of an agricultural machine according to the invention the agricultural machine is provided with a position-determining element for determining the position of the agricultural machine in the agricultural parcel.

Although for some agricultural parcels one value of the environment-property may be applied to the entire parcel (for example the colour), for improving safety it is advantageous if the memory is suitable for containing nominal values of the environment-property per position in the agricultural parcel. In this manner, for taking safety measures, it is possible to take into account the values of the environment-property that may be different per position in the agricultural parcel.

Although it is possible to change the direction of travel of the agricultural machine with the aid of data from the comparator, for further improvement of safety the agricultural machine preferably comprises a switch for deactivating the agricultural operation and/or the movement of the agricultural machine with the aid of data from the comparator. In this manner it is possible to stop the agricultural machine and/or the operation independently of the direction of travel. The agricultural machine preferably comprises a switch for deactivating the agricultural operation and/or the movement of the agricultural machine with the aid of data from the direction-of-travel-determining element.

The invention can in particular be applied if the agricultural machine is an autonomous agricultural machine, i.e. an agricultural machine that does not require a driver for being moved.

According to the present invention there is also provided a method of deactivating the operation of a movable agricultural machine, the method comprising: storing a nominal value of an environment-property related to an agricultural parcel; measuring a current value of the environment-property within a given measuring range of the agricultural machine; comparing the measured current value of the environment-property with the stored nominal value of the environment-property; generating a deactivation signal when the result of the comparison is outside a given value range; and deactivating the operation of the movable agricultural machine on generation of a deactivation signal.

Advantageously, the method further comprises determining a direction of travel of the agricultural machine and/or determining a braking distance of the agricultural machine; and adjusting the measuring range on the basis of one or both of these values.

### BRIEF DESCRIPTION OF DRAWINGS

An embodiment of the invention will now be explained in further detail by way of example only with reference to the accompanying figure, in which:

FIG. 1 shows schematically in plan view an autonomous agricultural machine in an agricultural parcel according to an embodiment of the invention.

### DETAILED DESCRIPTION

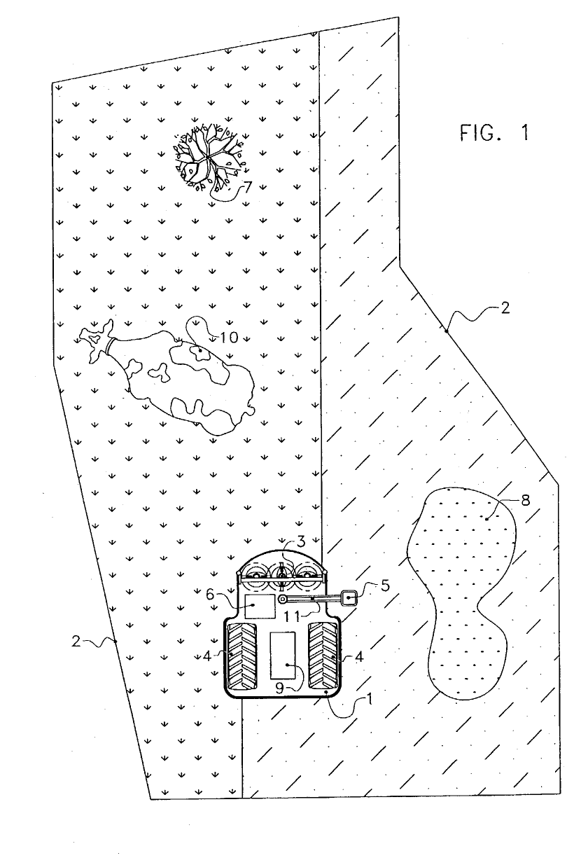

FIG. 1 shows schematically in plan view an autonomous agricultural machine 1 in an agricultural parcel 2. Although the invention will be described with reference to an autonomous agricultural machine, it will be obvious that the invention is not limited thereto. It is pointed out here that an autonomous machine, i.e. a machine that does not require a driver for being moved, is known per se and will therefore not be set out here in further detail for the sake of simplicity of the description. Such an autonomous machine may for instance be of the type described in U.S. Pat. No. 4,769,700 the contents of which are hereby incorporated by reference in their entirety.

Various aspects of an autonomous machine are also disclosed in co-pending United States patent applications: Serial No. â·¦â·¦entitled “An Agricultural Machine for Performing Crop Processing” Serial No. â·¦â·¦entitled “An Autonomous Agricultural Machine for Performing an Agricultural Operation, in Particular Crop Processing”; Serial No. â·¦â·¦entitled “A Device for Crop Processing”; Serial No. â·¦â·¦entitled “An Assembly for Performing Crop Harvesting”; Serial No. â·¦â·¦entitled “A System for and a Method of Performing a First and a Second Agricultural Operation on an Agricultural Parcel”; Serial No. â·¦â·¦entitled “An Assembly for Performing an Agricultural Operation, in Particular Crop Processing”; Serial No. â·¦â·¦entitled “An Agricultural Machine for Performing an Agricultural Operation, in Particular Crop Processing”; and Serial No. â·¦â·¦entitled “An Assembly and an Autonomous Agricultural Machine for Performing an Agricultural Operation, in Particular Crop Processing”, all of which claim priority in the Netherlands on Jun. 6, 2002. The contents of all of these applications are hereby incorporated by reference in their entirety.

The autonomous agricultural machine 1 is suitable for performing a crop-processing operation on a crop that is present on the agricultural parcel 2. In the embodiment shown the autonomous agricultural machine 1 is an autonomous mowing machine that mows crop that is present on the agricultural parcel 2 by means of a mowing unit 3. Although several sorts of mowing units known per se may be used, in the embodiment shown the mowing unit 3 is constituted by mowing discs that are present on a cutter bar and are rotatable about an axis, which mowing discs are provided with mowing knives. It will be obvious that the agricultural machine may also be an agricultural machine for performing other crop-processing operations.

The agricultural machine 1 is supported and moved over the agricultural parcel 2 by means of wheels 4. The autonomous agricultural machine 1 further comprises an environment-sensor 5 for measuring a current value of an environment-property. In the embodiment shown the environment-sensor 5 is a colour-sensor for measuring the colour. However, it will be obvious that also other sensors, such as sensors that are suitable for measuring structure, temperature, size, humidity content and the like, are applicable within the scope of the invention. The agricultural machine 1 further comprises a memory 6 for containing a nominal value of the environment-property. In the present case the memory is suitable for containing nominal values of the environment-property per position in the agricultural parcel 2, so that a tree 7, a pond 8 and the remaining part of the agricultural parcel 2 can be distinguished from each other. The data may be stored for example in the form of a ground plan in which the parts 7, 8 of the agricultural parcel 2 are indicated by different colours.

The agricultural machine 1 further comprises a comparator 9 for comparing the measured current value of the environment-property, for example a measurement of the colour of a cow 10 present in the agricultural parcel, with the stored nominal value of the environment-property. For this purpose the agricultural machine further comprises a position-determining element (not-shown) that is known per se for determining the position of the autonomous agricultural machine 1 in the agricultural parcel 2 by means of for example a GPS-system. Other well known positioning systems may also be used including DGPS, Galileo, or position determination by means of beacons and the like. Said position-determining element may also be used as a direction-of-travel-determining element for determining the direction of travel of the agricultural machine 1. This makes it possible to take relevant safety measures when the agricultural machine 1 comes too near to the cow 10, or the pond 8 or the tree 7. Other direction of travel elements known per se, may also be used, including compass based systems, gyroscope based devices, inclinometers and the like.

The agricultural operation and/or the movement of the agricultural machine are/is stopped in particular with the aid of data from the comparator 9, preferably in combination with data from the direction-of-travel-determining element or the position-determining element.

The expected braking distance of the agricultural machine 1 depends on many factors. It depends on the speed of travel and the condition of the brakes. It also depends on the weight of the agricultural machine 1 and any braking effect due to the agricultural operation being conducted e.g. raking or harrowing. It may also depend on the position of the agricultural machine 1 in the agricultural parcel 2 (for example, the agricultural machine moves slower in loose soil than on a hard soil surface). It may also depend on the direction of travel (for example, uphill and downhill the braking distances and driving speeds are different). These factors may be determined and supplied, to a braking-distance-determining element whereby the expected braking distance of the agricultural machine 1 can be continuously determined. In particular, by means of the position-determining element, the braking distance per position in the agricultural parcel 2 may be evaluated. This makes it possible to take a specific safety measure in dependence on the expected speed. This may be achieved by providing a topographical relief model of the agricultural parcel 2. Using such a model, it is possible to determine for any given location and for any given direction of travel, whether the agricultural machine 1 will be traveling uphill or downhill and to what extent. It may also be possible to use the environment-sensor 5 to provide information concerning the conditions of the ground surface at a given location and to calculate the braking distance on the basis of the information from the environment-sensor 5.

The measuring range of the environment-sensor 5 is adjustable by placing for example different collecting lenses before the sensor. The measuring range of the environment-sensor is in particular adjustable with the aid of data from the braking-distance-determining element, in order that, if the braking distance is long, there is detected at a further distance in front of the agricultural machine than if the braking distance is short. In this manner it is possible timely to stop the agricultural machine and/or to take other safety measures, if necessary, before the detected object has been reached.

The environment-sensor 5 is disposed on the agricultural machine 1 so as to be movable on a rotatable arm 11. By making use of the position-determining element, it is possible to determine the direction of travel of the agricultural machine, and it is possible to rotate the arm 11 in such a way that the measuring range of the sensor is situated in the direction of travel of the agricultural machine.

Many modifications in addition to those described above may be made to the structures and techniques described herein without departing from the spirit and scope of the invention. In particular, the devices and methods disclosed herein may also be used in conjunction with further features of the above-referenced co-pending applications. Accordingly, although specific embodiments have been described, these are examples only and are not limiting upon the scope of the invention.

1. An agricultural machine for performing an agricultural operation, the agricultural machine being movable over an agricultural parcel and comprising:
an environment-sensor for measuring a current value of an environment-property;
a memory for storing a nominal value of the environment-property;
a comparator for comparing the measured current value of the environment-property with the stored nominal value of the environment-property; and
a braking-distance-determining element for determining a braking distance for the agricultural machine.

2. The agricultural machine as claimed in claim 1, further comprising a direction of travel-determining element for determining the direction of travel of the agricultural machine and wherein the braking-distance-determining element calculates the braking distance on the basis of the direction of travel.

3. The agricultural machine as claimed in claim 1 wherein a measuring range of the environment-sensor is adjustable with the aid of data from the braking-distance-determining element.

4. The agricultural machine as claimed in claim 2, wherein the environment-sensor is movably disposed on the agricultural machine.

5. The agricultural machine as claimed in claim 4, wherein the environment-sensor is movable with the aid of data from the direction of-travel-determining element.

6. The agricultural machine as claimed in claim 1, wherein the agricultural machine further comprises a position-determining element for determining the position of the agricultural machine in the agricultural parcel.

7. The agricultural machine as claimed in claim 6, wherein the memory contains nominal values of the environment-property per position in the agricultural parcel.

8. The agricultural machine as claimed in claim 1, wherein the agricultural machine comprises a switch for deactivating the agricultural operation or the movement of the agricultural machine with the aid of data from the comparator.

9. The agricultural machine as claimed in claim 8, wherein the switch deactivates the agricultural operation or the movement of the agricultural machine partially with the aid of data from the braking-distance-determining element.

10. An autonomous agricultural machine for performing an agricultural operation, the autonomous agricultural machine being movable over an agricultural parcel and comprising:
an environment-sensor for measuring a current value of an environment-property;
a memory for storing a nominal value of the environment-property;
a comparator for comparing the measured current value of the environment-property with the stored nominal value of the environment-property;
a direction-of-travel-determining element for determining the direction of travel of the autonomous agricultural machine; and
a braking-distance-determining element for determining the braking distance of the autonomous agricultural machine.

11. The autonomous agricultural machine as claimed in claim 10, wherein a measuring range of the environment-sensor is adjustable with the aid of data from the braking-distance-determining element.

12. The autonomous agricultural machine as claimed in claim 10 wherein a measuring range of the environment-sensor is adjustable with the aid of data from the direction-of-travel-determining element.

13. The autonomous agricultural machine as claimed in claim 10, wherein the environment-sensor is movably disposed on the autonomous agricultural machine.

14. The autonomous agricultural machine as claimed in claim 13, wherein the environment-sensor is movable with the aid of data from the direction-of-travel-determining element.

15. The autonomous agricultural machine as claimed in claim 10, wherein the autonomous agricultural machine further comprises a position-determining element for determining the position of the autonomous agricultural machine in the agricultural parcel.

16. The autonomous agricultural machine as claimed in claim 15, wherein the memory contains nominal values of the environment-property per position in the agricultural parcel.

17. The autonomous agricultural machine as claimed in claim 10, wherein the autonomous agricultural machine comprises a switch for deactivating the agricultural operation or the movement of the autonomous agricultural machine with the aid of data from the comparator.

18. The autonomous agricultural machine as claimed in claim 17, wherein the switch deactivates the agricultural operation or the movement of the autonomous agricultural machine partially with the aid of data from the direction-of-travel-determining element.

19. A method of controlling the operation of a movable agricultural machine, the method comprising:
storing a nominal value of an environment-property related to an agricultural parcel;
measuring a current value of the environment-property within a given measuring range of the agricultural machine;
comparing the measured current value of the environment-property with the stored nominal value of the environment-property;
generating a control signal when the result of the comparison is outside a given value range; and
controlling the operation of the movable agricultural machine in response to the control signal.

20. The method as claimed in claim 19, further comprising:
determining a braking distance of the agricultural machine; and
adjusting the measuring range on the basis of the braking distance.

21. The method as claimed in claim 20, further comprising:
determining a direction of travel of the agricultural machine and determining the braking distance on the basis of the direction of travel.
